(19) United States
(12) Patent Application Publication
(10) Pub. No.: US 2002/0004832 A1
(43) Pub. Date: Jan. 10, 2002

(54) Method for establishing communication channel using information storage media

(75) Inventors: Yeo-hwan Yoon, Seoul (KR); Seung-oh Han, Seoul (KR)

Correspondence Address: Shanks & Herbert, TransPotomac Plaza, Suite 306, 1033 N. Fairfax Street, Alexandria, VA, 22314, US

(73) Assignee: Yage Co., Ltd.

(21) Appl. No.: 09/758,951

(22) Filed: Jan. 12, 2001

(30) Foreign Application Priority Data
Jan. 12, 2000 (KR) 2000-1390
Aug. 22, 2000 (KR) 2000-48473

(51) Int. Cl. G06F 15/16

(52) U.S. Cl. 709/229; 713/155

(57) ABSTRACT

A method for establishing a communication channel between a local computer and an Internet server for facilitating a user of the local computer having an information storage medium to access the Internet server providing additional services related to contents stored in the medium in order to receive such additional services. The method supports an establishment of the communication channel between a client computer capable of accessing an information storage medium which stores predetermined information contents and a connection information including medium identification data and a first remote server providing services related to the information contents through a open communication network. The second remote server receives a connection authentification request message from the client computer through the open communication network, which message includes the medium identification data. The second remote server compares the received connection authentification request message with the medium identification reference data stored in the storing means. When the medium identification data is same as the medium identification reference data, the second remote server generates an access code for the client computer to access the first remote server and transmits an encrypted access code to the client computer. Thus, the client computer can try to establish a connection to the first remote server using the access code and receive the services.

### BACKGROUND OF THE INVENTION

1. Field of the Invention

The present invention relates to a communication method and, more particularly, a method for establishing a communication channel between a client terminal and an Internet server. This application for a communication method is based on Korean patent application Nos. 2000-1390 and 2000-48473 which are incorporated by reference herein for all purposes.

2. Description of Related Arts

When a user wishes to acquire information from an Internet server providing toll services according to Hypertext Transfer Protocol (HTTP) or File Transfer Protocol (FTP), the user typically executes a suitable program, e.g., a web browser or an FTP program, inputs an address (e.g., a URL in case of transceiving according to the HTTP) to set up a physical channel, and inputs his or her user name (ID) and password to establish a logical or effective channel. Commonly, the ID and password are assigned to the user upon payment of a certain fee before the first access of the toll services. However, It may be troublesome for the user to memorize and input the ID and password to access the services especially when the user wishes to receive the information services from a plurality of Internet servers.

On the other hand, various kinds of computer-readable mediums for distributing information such as sounds, moving pictures, and digital data are widely being used nowadays. Such computer-readable mediums may be music CDS, CD-ROMs, video CDS, or DVDs and typically are produced and distributed in large volumes by the producers. Since the information storage mediums contain static information which is not updated automatically, the value of the information stored in the mediums gradually degrades as time goes by. Thus, it is frequently necessary for the stored information to be modified or compensated with additional information. For meeting to such needs, some producers or distributors notify the medium users the generation of additional information through an off-line communication channel, for example, by a postcard. The off-line notification, however, has a problem that the message is not sure to be delivered to the recipient because of change of the address of the recipient or the other reasons. Furthermore, the added information cannot be consolidated physically with the original contents, which lowers the benefits of the added information.

In this regard, more medium producers or distributors are providing, through Internet, the additional information related to the contents in the information storage medium. For example, lots of CD-ROM manufacturers and book publishers inscribe, on the face of such products, the URLs of web sites related to the products, so that respective users can obtain additional services from the web site through the Internet. Such web sites may be open to all persons concerned with the services. Alternatively, the web sites may allow accesses only for those having IDs and passwords, which may be provided with the information storage medium or obtained through a separate subscription procedure.

Opening the web site to all persons concerned with the services unconditionally may be unequitable or result in relative disadvantage to the purchaser of the information storage medium because the purchaser cannot receive more favorable services than those having not the storage medium, The provision of the separate subscription procedure is of little significance compared with the unconditional services because it is impossible to verify whether a new subscription applicant have purchased the storage medium. Further, in case that the subscription process incurs any costs to the operator of the Internet server and thus the operator wishes to charge fees to the subscribers, the maintenance of subscription procedure and billing may become some burden to the operator. In case that the ID and password are provided when selling the contents, the user happens to face of the trouble of memorizing and inputting the ID and password whenever accessing the services while the medium producer has to spend additional managerial costs for generating and printing such data on all their products.

### SUMMARY OF THE INVENTION

To solve the above problems, one object of the present invention is to provide a method for establishing a communication channel between a local computer and an Internet server for facilitating the access of a user having an information storage medium to the Internet server providing additional services related to contents stored in the medium for receiving such additional services.

Another object of the present invention is to provide a computer-readable medium for storing data and program suitable for implementing the method for establishing the communication channel.

In order to achieve one of the above objects, there is provided a method for supporting an establishment of a communication channel between a client computer capable of accessing an information storage medium which stores predetermined information contents and a connection information including medium identification data and a first remote server providing services related to the information contents through an open communication network. The method for supporting an establishment of a communication channel is implemented in a second remote server including means for storing medium identification reference data required to be identical with the medium identification data.

The second remote server receives a connection authentification request message from the client computer through the open communication network, which message includes the medium identification data. The second remote server compares the received connection authentification request message with the medium identification reference data stored in the storing means. When the medium identification data is the same as the medium identification reference data, the second remote server generates an access code for the client computer to access the first remote server and transmits an encrypted access code to the client computer. Thus, the client computer can try to establish a connection to the first remote server using the access code and receive the services.

There may be multiple first remote servers, some of which may be operated by the operator of the second remote server and have the same network address with the second remote server.

In case that the network address of the first remote server is different from that of the second remote server, it is preferable that the access code is preferably encrypted before provided to the client computer in order to enhance the security. Also, it is preferable that the second remote server transmits an authentification notifying message including the access code to the first remote server, so that the first remote server provides the services to the client computer after verifying validity of the access code when the client computer requests a connection. The connection authentification request message may further include an address of the client computer. In such a case, the authentification notifying message further includes the address of the client computer, so that the first remote server verifies validity of the access code as well as the validity of the address of the client computer when the client computer requests the connection. Meanwhile, the authentification notifying message preferably includes time data for setting an expiration period of the access code. In such a case, the first remote server invalidates the access code when the client computer does not request the connection within the expiration period.

At least a portion of the connection authentification request message may be encrypted according to a predetermined encryption algorithm. In such a case, the second remote server decrypted the encrypted portion of the connection authentification request message before the authentification.

On the other hand, when the first and the second remote servers have the same network address with each other, it is unnecessary to transfer the authentification notifying message from the second to the first remote servers. Also, the additional services may be provided directly by the second remote server after analyzing the connection authentification request message. In such a case, the access code preferably includes a Cookie value transmitted from the second remote server to the client computer through a Cookie-setting field to be stored in the client computer.

A computer readable medium for achieving another one of the above objects stores a program for setting up a communication channel between a client computer and a first remote server through an open communication network in a condition that the client computer can access an information storage medium storing predetermined information contents and a connection information including medium identification data and address data of a second remote server. The computer readable medium may be the same as the information storage medium, in which case the information contents, the connection information, and the program are stored in a single medium.

The program carries out the functions of: (a) making a connection authentification request message generated based on the connection information to be transmitted to the second remote server through the open communication network; (b) receiving and decoding a connection authentification message provided by the second remote server in response to the connection authentification request message to recover an access code assigned by the second remote server; and ∇ providing the access code to a predetermined client program operating in the client computer so that the client program tries to establish a connection to the first remote server using the access code and receive services related to the information contents from the first remote server.

Regarding the function (a), the connection authentification request message may be generated by either the client program or the program of the present invention. In the case that the connection authentification request message is generated by the client program, the program of the present invention provides the client program with the medium identification data and the address data of the second remote server, and the client program generates the request message using the medium identification data and transmits the request message to the second remote server. Here, the program of the present invention may encrypt the medium identification data to provide the client program with an encrypted medium identification data and the address data of the second remote server.

In the case that the connection authentification request message is generated by the program of the present invention, at least a portion of the connection authentification request message may be encrypted as well. Also, even through the program of the present invention generates the request message, the transmission of the request message to the second remote server may be carried out by the client program. Of course, it is possible for the program of the present invention to directly transmit the request message to the second remote server.

According to the present invention, the user can easily access the Internet server providing services related to the information contents stored in the information storage medium without memorizing and inputting the ID and password. Also, the distributor of the medium or the operator of the first or the second remote server can provide differentiated services to the purchaser of the medium from those having not the medium. In particular, since a different access code may be assigned for each access, the probability for the access code to be appropriated is significantly lowered

### BRIEF DESCRIPTION OF THE DRAWINGS

The above objectives and advantages of the present invention will become more apparent by describing in detail preferred embodiments thereof with reference to the attached drawings, in which:

FIG. 1 illustrates an example of a system for implementing the method of the present invention;

FIG. 2 illustrates examples of programs loaded in a main memory of a local computer to be executed when the method of the present invention is carried out;

FIG. 3 illustrates examples of information stored in the storage medium shown in FIG. 1;

FIG. 4 is a flowchart illustrating a preferred embodiment of the method for establishing a communication channel according to the present invention;

FIG. 5 is a flowchart illustrating the initiation of the communication channel establishment and process of information acquisition in the local computer shown in FIG. 1;

FIG. 6 is a flowchart illustrating the authentification process carried out by the connection authentification server shown in FIG. 1;

FIG. 7 is a flowchart illustrating a connection procedure in the target Internet server shown in FIG. 1 in the case that the local computer requests services according to an HTTP; and

FIG. 8 is a flowchart illustrating a connection procedure in the target Internet server shown in FIG. 1 in the case that the local computer requests services according to a protocol other than the HTTP.

### DETAILED DESCRIPTION OF PREFERRED EMBODIMENTS

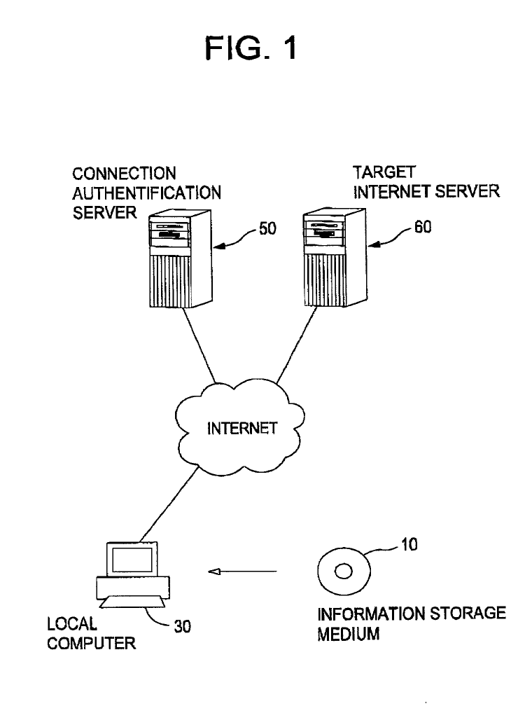

Referring to FIG. 1, a system for implementing the method of the present invention includes a local computer 30, a connection authentification server 60, and a target internet server 60.

The local computer 30 may be loaded with an information storage medium 10 to read out and recover contents stored in the medium 10 and is capable of being connected to an authentification server 50 and a target internet server 60 through Internet. The target internet server 60 provides additional services related to the contents stored in the medium 10 in response to the request of the local computer 30. In this description, “additional services” include at least one of the services: providing of updated contents, relevant moving pictures, news, and the other kinds of data, or selling of relevant products. The connection authentification server 50 authentificates the access of the local computer 30 to the target internet server 60. In this description, the term “authentification” means the process of verifying that the local computer 30 is loaded with a legitimate medium 10 and assisting the log-in of the user of the local computer 30 to the target server 60. For the authentification process, the connection authentification server 50 maintains identification data for each storage medium 10 and addresses of target internet server 60.

Even though there is shown a single target internet server 60 in FIG. 1, multiple target servers 60 may be associated with the connection authentification server 50. Also, the connection authentification server 50 and the target internet server 60 are shown separately in FIG. 1, these skilled in the art will understand that at least target internet server 60 may be implemented in the same physical server as the connection authentification server 50. In the description including the appended claims, the servers 50 and 60 are differentiated from each other in the viewpoint of their function only.

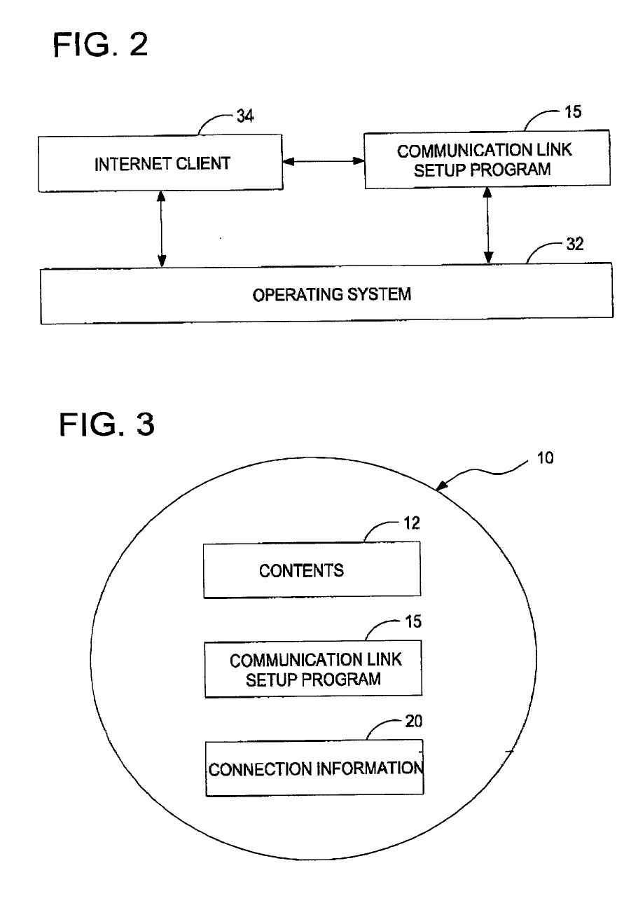

FIG. 2 illustrates examples of programs loaded in a main memory of a local computer 30 to be executed when the method of the present invention is carried out. The programs include an operating system 32, at least one internet client 34, and a communication link setup program 15 according to the present invention. Examples of the operating system 32 include Windows95, Windows98, Windows2000, WindowsNT, WindowsCE (all of which are provided by Microsoft Corporation and trademarks of Microsoft), and Linux. The internet client 34, a program used for receiving and transmitting information from and to an external server connected to the Internet, may be a web browser or an FTP program. The communication link setup program 15 is a program for implementing the method of the present invention. The function and operation of the communication link setup program 15 will be described in detail below. On the other hand, the term “local computer” is not limited to a personal computer but refers to any kind of data terminal which can read the information stored in the information storage medium 10 and has a network access function.

The information storage medium 10 is produced and distributed by the operator of the connection authentification server 50 or the target internet server 60, or the other person, and carries information which can be read out by the local computer 30. Examples of the information storage medium 10 include, but are not limited to, CD, CD-ROM, DVD, and DVD-ROM. FIG, 3 illustrates examples of information stored in the storage medium shown in FIG. 1. As shown in the drawing, stored information includes contents 12, such as music, image, and a combination of image and text, as well as the communication link setup program 15 and a connection information 20.

The communication link setup program 15, which initiates the process of the present invention, may be executed after being copied to the local computer 15 or as it is in the storage medium 10 to generate a connection authentification request message which is transmitted to the target internet server 60 for establishing a connection thereto and carry out other control operations necessary for the connection. In order to fulfill such functions, the communication link setup program 15 performs operations of: processing the connection information 20 and information on the local computer 30 (e.g., Internet protocol (IP) address, a hardware configuration, and so on) to transmit the processed data to the connection authentification server 50, decoding temporary ID and password from data from the connection authentification server 50, and transferring the temporary ID and password to the internet client 34 for the internet client program 34 to be connected to the target internet server 60.

In a preferred embodiment, the communication link setup program 15 is automatically executed, according to an automatic execution function of the operating system, just after the information storage medium 15 is loaded into the local computer. Alternatively, however, the communication link setup program 15 may be executed according to an instruction provided by the user. In another alternative embodiment where the contents 12 are organized in web document forms, such as HTML pages, s including buttons for network connections and the communication link setup program 15 is linked to such buttons, the communication link setup program 15 may be automatically executed when the user clicks one of the network connection buttons. On the other hand, the communication link setup program 15 may be provided to the user as a separate program such as a plug-in rather than by being recorded in the information storage medium 10.

The connection information 20, which is used by the communication link setup program 15 when the user tries to make a connection to the target internet server 60 by use of the information storage medium 10, includes the Internet address of the connection authentification server 50 and an identification data “I” of the medium 10. In case of a music CD, for example, the identification data “I” may be the album title. In such a case, the CDs of the same music data have the same identification data “I” with one another. Alternatively, the connection information 20 of each medium 10 may further include a unique serial number assigned by the manufacturer. For example, for the music CD mentioned above, the identification data “I” may have a form “[VER] 0.1 [MUSICIAN] SOMEONE [ALBUM] SOMEALBUM_NAME [ID] 00000001”, which is written in the lead-in or lead-out area. More details of the identification data will be described below.

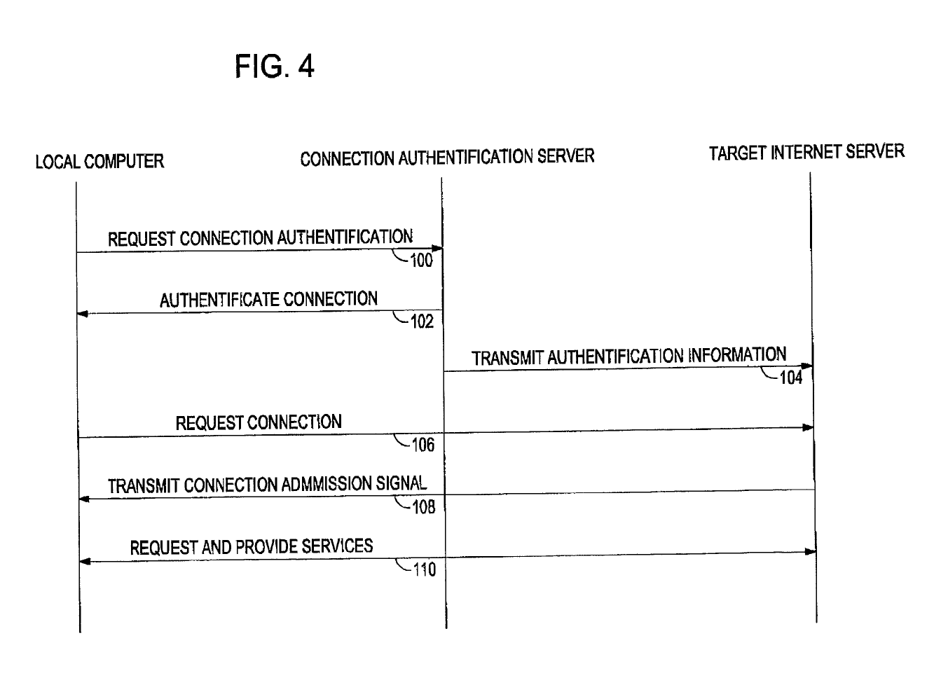

FIG. 4 illustrates a preferred embodiment of the method for establishing a communication channel according to the present invention. Before requesting services to the target internet server 60, the local computer 30 requests a connection authentification to the connection authentification server 50 in step 100. In a preferred enbodiment, the connection authentification request message includes, in its header, some of the connection information read out from the medium 10 and the identification data of the local computer 30. The connection authentification server 50 verifies the validity of the connection authentification request, and generates and encrypts the temporary ID and password to transmit a connection authentification message including the encrypted data (step 102). Also, the connection authentification server 50 provides an authentification notifying message including the temporary ID and password to the target internet server 60, so that the target internet server 60 verifies the validity of the temporary ID and password when the local computer 30 requests a connection (step 104).

In step 106, the communication link setup program 15 decrypts the received data to restore the temporary ID and password, and the internet client 34 requests a connection using the temporary ID and password. Responsive to the connection request message, the target internet server 60 compares the temporary ID and password included in or following the connection request message with those from the connection authentification server 50. If two kinds of data are identical respectively, the target internet server 60 transmits a connect admission message to the local computer 30 (step 108) Accordingly, the internet client 34 of the local computer 30 may request services to the target internet server 60 and receive the requested services (step 110).

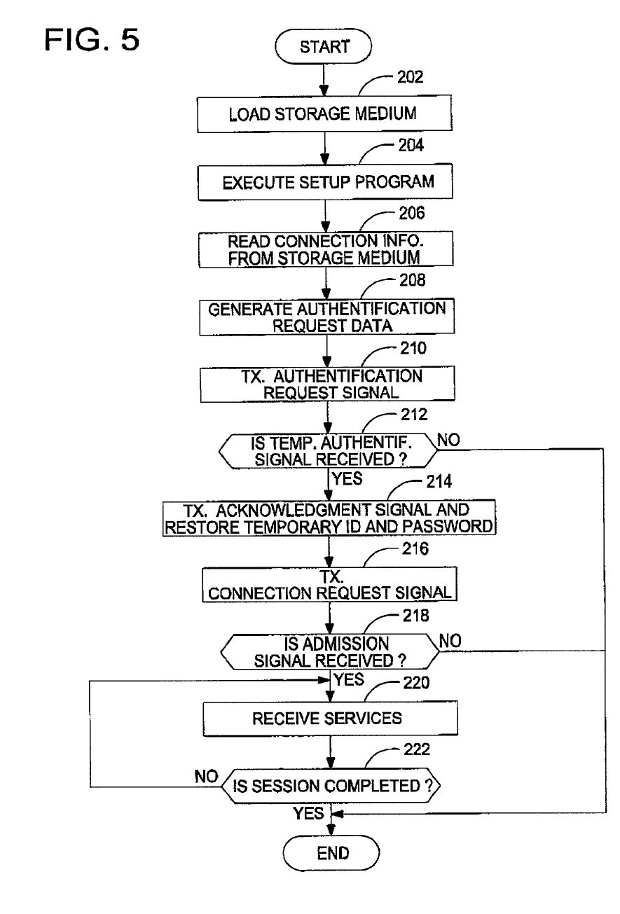

FIG. 5 illustrates the processes of initiation of the communication channel establishment and information acquisition in the local computer shown in FIG. 1. Hereinbelow, it is assumed that the information storage medium 10 is a music CD.

The information storage medium 10 is loaded in step 202, and then the communication link setup program 15 in the information storage medium 10 is executed in step 204. In case that the local computer 30 is equipped with the program autoexecution function, the communication link setup program 15 is automatically executed just after the information storage medium 10 is loaded into the local computer 30. If, however, the local computer 30 is not equipped with the program autoexecution function, the user may execute the communication link setup program 15 by inputting an appropriate instruction.

While the communication link setup program 15 is being executed, the local computer acquires the connection information 20 included in the information storage medium 10 and additional data (step 206). As mentioned above, the connection information 20 includes the identification data I, the addresses of the connection authentification server 50 and the 66. The additional data preferably includes the IP address “N” of the local computer 30 and medium-related data “M” associated with the information storage medium 10.

In step 208, the communication link setup program 15 generates authentificaticn request data “X” according to an encryption algorithm “K”. For example, assuming that the address of the connection authentification server 50 is “www.someserver.com” or “192.68.0.1” and the identification data “I” of the information storage medium 10 is “[VER] 0.1 [MUSICIAN] SOMEONE [ALBUM] SOMEALBUM_NAME [ID] 00000001” as exemplified above, the communication link setup program 15 generates the authentification request data “X”, according to a encryption algorithm “K”, to be transmitted to the connection authentification server 50 having the address of “www.someserver.com” or “192.68.01”. The authentification request data “X” may be defined as follows:

X=f(I,N,M,K) (1)

In the equation 1, f denotes the encrypting function. For the example of music CD above, the authentification request data “X” may be “[VER] 0.1 [MUSICIAN] SOMEONE [ALBUM] 1 [ALBUM NAME] SOMEALBUM_NAME [ID] 00000001 [CLIENT] 001.00.01 [IP] 192.68.0.2 [VID] ABCDE123.” Here, “[VER] 0.1” denotes the version of the authentification request data “X”, “[MUSICIAN] SOMEONE” denotes the musician, “[ALBUM] 1” denotes the album number serially assigned in the viewpoint of the musician, “[ALBUM NAME] SOMEALBUM_NAME” denotes the title of the album, and “[ID] 00000001” denotes the unique serial number of the album. “[CLIENT] 001.00.01” denotes the version of the communication link setup program 15, “[IP] 192.68.0.2” denotes the lP address of the local computer 30, and “[VID] ABCDE123” denotes the volume ID assigned when the CD had been produced. It should be noted that the authentification request data “X” exemplified above illustrates the variables determining the data for the purpose of the explanation, and the actual data “X” has an encrypted form, such as “001cdkj038dfjd213dfdfdjs”, which is readable only by a legal computer.

Even though the authentification request data “X” is encrypted according to an algorithm embedded in the communication link setup program 15 in the present embodiment, another algorithm, such as commonly available Secured Socket Layer (SSL) and Transport Layer Security (TLS), might be used as well. If no encryption algorithm is used in the generation of the authentification request data “X” and thus raw data “X” including the identification data “I”, the IP address “N” of the local computer 30 and the medium-related data “M” are transmitted through the Internet, it is possible that somebody appropriate such date and log in the target internet server 60 without the information storage medium 10.

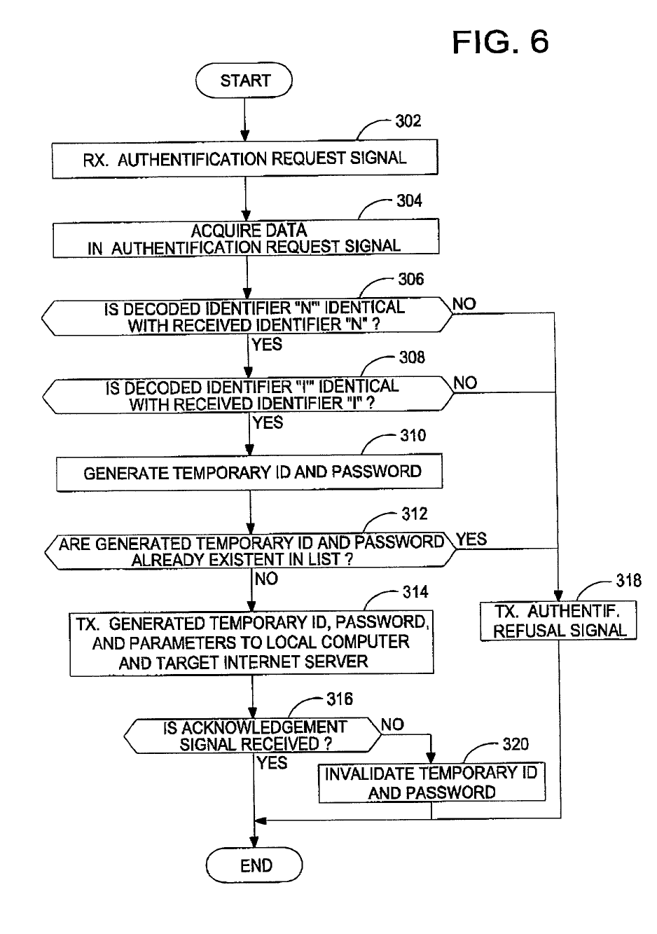

In step 210, the internet client 34 transmits a connection authentification request signal “R_X” including the authentification request data “X” to the connection authentification server 50. Responsive to the connection authentification request signal “R_X”, the connection authentification server 50 generates and encrypts a temporary connection authentification signal “Y” to transmit to the local computer 30. The process performed by the connection authentification server 50 will be described below in detail with reference to FIG. 6.

In step 212, the local computer 30 determines whether the temporary connection authentification signal “Y” is received from the connection authentification server 50. If it is determined that the temporary connection authentification signal “Y” is not received in the step 212, the connection procedure is terminated. Meanwhile, if it is determined that the temporary connection authentification signal “Y” is received in the step 212, the procedure proceeds into step 214.

In the step 214, the communication link setup program 15 of the local computer 30 transmits an acknowledgment signal “ACK” to the connection authentification server 50 and decrypts the temporary connection authentification signal “Y” to restore the temporary ID and password “P” and transfer those data to the internet client 34.

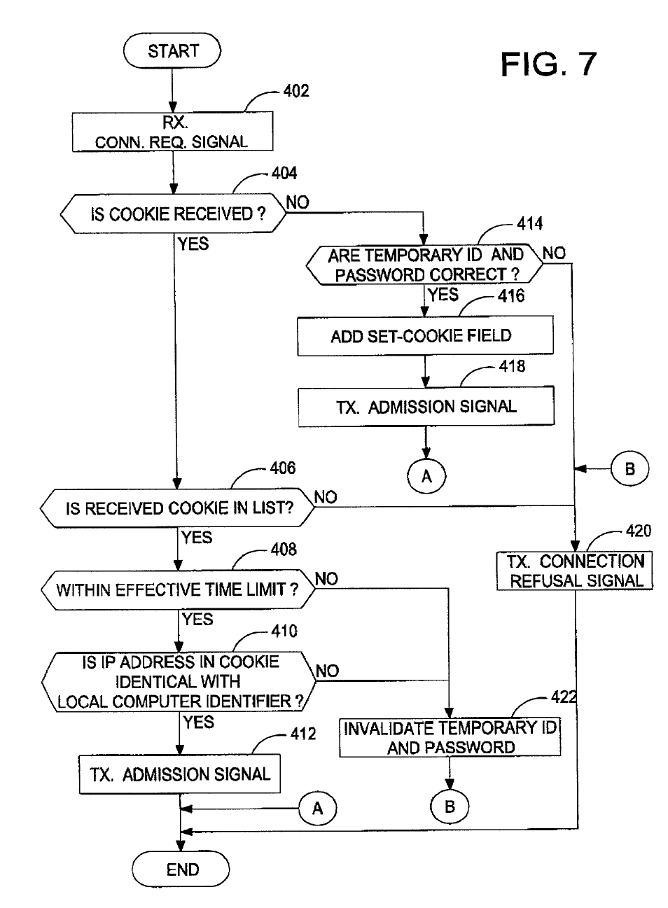

In step 216, the internet client 34 transmits a connection request signal “R_C” to the target internet server 60. The connection request signal “R_C” includes the temporary ID and password “P”, e.g., in the header in case of using the HTTP. Responsive to the connection request signal “R_C”, the target internet server 60 generates a connection admission signal “C_P” and transmits the signal to the local computer 30 through the Internet. The process performed by the target internet server 60 will be described below in detail with reference to FIG. 7.

In step 218, the communication link setup program 15 of the present invention checks whether the connection admission signal “C_P” is received from the target internet server 60. If it is determined that the connection admission signal “C_P” is not received in the step 218, the connection procedure is terminated. Meanwhile, if it is determined that the connection admission signal “C_P” is received in the step 218, the procedure proceeds into step 220.

In the step 220, the user receives the services related to the contents information stored in the information storage medium 10. The step 220 goes on until the user terminates the connection session If it is determined that the session is completed in step 222, the connection procedure is terminated. Meanwhile, if it is determined that the session is not completed in the step 222, the procedure returns to the step 220.

The authentification process carried out by the connection authentification server 50 will now be described in detail with reference to FIG. 6.

In step 302, the connection authentification server 50 receives the connection authentification request signal “R_X” including the authentification request data “X”. In step 304, the connection authentification server 50 decrypts the authentitication request data “X” in the connection authentification request signal “R_X” according to a certain decryption algorithm to obtain the identification data “I′”, the IP address “N′” of the local computer 30 and the medium-related data “M′”.

In step 306, the connection authentification server 50 determines whether the local computer identifier “N” received along with the connection authentification request signal “R_X” is identical with the decoded identifier “N′”. As described above, the local computer identifier “N”, corresponding to the IP address of the local computer 30 and being capable of obtained according to the Internet protocol, is provided by the local computer 30 along with the connection authentification request signal “R_X”. In case of Internet services using HTTP, for example, the local computer appends such data to the connection request or the HTTP request, which is automatically carried out by the web browser.

If it is determined, In step 306, that the appended local computer identifier “N” differs from the decrypted identifier “N”, the connection authentification server 50 regards the authentification request data “X” as having been appropriated and directs the process to step 318. In such a case, the connection authentification server 50 transmits a connection refusal signal “D_C” to the local computer 30 and terminates the connection procedure. For example, if the decrypted local computer identifier “N′” is the IP address “192.68.0.1” while the appended local computer identifier “N” is the IP address “192.68.0.2”, the connection authentification server 50 determines that the local computer wishes to be authentificated differs from the computer currently requesting the authentification and refuses the authentification. On the other hand, If it is determined that the appended identifier “N” is identical with the decrypted identifier “N′” in the step 306, the procedure proceeds to step 308.

In the step 308, the connection authentification server 50 compares the decrypted medium identifier “I” with the identifier “I” maintained by the connection authentification server 50. Here, it is assumed that the identifier “I” was registered with the connection authentification server 50 just after the information storage medium 10 had been produced. If it is determined, in step 308, that the decrypted medium identifier “I′” differs from the registered identifier “I′” the connection authentification server 50 regards the medium identifier or the medium itself as having been forged or appropriated and directs the procedure to step 318. In this case, the connection authentification server 50 transmits a connection refusal signal “D_C” to the local computer 30 and terminates the connection procedure. On the other hand. If it is determined that the decrypted medium identifier “I′” is identical with the registered identifier “I” in the step 308, the procedure proceeds to step 310.

Even though not shown in FIG. 6, a step of comparing the decrypted medium-related data “M′” with the data “M” stored previously in the connection authentification server 50. Similarly to the medium identifier “I”, the medium-related data “M” stored in the connection authentification server 50 may have been registered with the connection authentification server 50 just after the information storage medium 10 had been produced.

Subsequently, in step 310, the connection authentification server 50 generates the temporary ID and password “P” using several parameters which include, but are not limited to, the medium identifier “I′”, the local computer identifier “N′”, the medium-related data “M′”, an authentification time “T”, and a random number “R”.

When the local computer identifier “N′” is used for the generation of the temporary ID and password “P”, the local computer identifier “N′” may be provided to the target internet server 60 while being stored in the connection authentification server 50, so that only the qualified local computer 30 corresponding to the identifier can use the temporary ID and password “P”. In other words, the target internet server 60 may grant a connection only to a local computer 30 of which the local computer identifier “N” is the same as the identifier “N′” received from the connection authentification server 50.

The authentification time “T” is used by the target internet server 60 to determine whether the local computer 30 receiving the temporary ID and password “P” accesses the target internet server 60 by a certain effective time limit. Though the effective time limit is typically used to check the timing of the first access to the target internet server 60 after the assignment of the the temporary ID and password “P”, it is preferable that the counting of the effective time limit is not stopped expire even after the local computer 30 first accesses the server 60. Owing to such effective time limit, a person other than the user who received the temporary ID and password “P” cannot access the target internet server 60 in the case that plural users share the local computer 30. Thus, in the preferred embodiment, the temporary ID and password “P” is invalidated when the effective time limit lapses or a predetermined service session provided by the target internet server 60 is completed. The random number “R” makes it difficult for an internet server other than the connection authentification server 50 to illegally duplicate the temporary ID and password “P”, which enhances the reliability of the system particularly when the scheme of generating the temporary ID and password “P” becomes known to the operator of the server.

In step 312, the connection authentification server 50 compares the temporary ID and password “P” with those generated recently and stored in the server 50. If the temporary ID and password “P” are found to be identical with a pair generated recently and stored in the server 50, the procedure proceeds to the step 318 to transmit the connection refusal signal “D_C” to the local computer 30. If the temporary ID and password “P” do not exist in the server 50, the procedure proceeds to step 314. The connection authentification server 50 stores the temporary ID and password “P” in its database and transmits such data to the local computer 30 and the target internet server 60. Also, all the parameters used for generating the temporary ID and password are transmitted to the target internet server 60.

As mentioned above, the temporary ID and password are encrypted along with the address of the target internet server 60, according to the encryption algorithm, into the temporary connection authentification signal “Y” before being transmitted to the local computer 30 and the target internet server 60. The temporary connection authentification signal “Y” may be defined as follows:

Y=f(ID,PAd,K) (2)

Here, f denotes the encryption function, K denotes the employed encryption algorithm, ID denotes the temporary ID, and Ad denotes the address of the target internet server 60.

After the transmission of the temporary connection authentification signal “Y” to the local computer 30, the connection authentification server 50 waits for receipt of an acknowledgment signal “ACK” from the local computer 30 (step 316). If the acknowledgment signal “ACK” is not received within a certain time period from the transmission of the temporary connection authentification signal “Y”, the connection authentification server 50 determines that there happened a connection error or failure. In such a case, the connection authentification server 50 invalidates the temporary ID and password “P” in step 320, notifies the fact to the target internet server 60, and terminates the connection procedure.

The connection procedure in the target Internet server 60 will now be described in detail with reference to FIG. 7, in the case that the local computer requests services according to an HTTP.

First, the target internet server 60 receives an HTTP request, the connection request signal “R_C”, from the local computer 30 in step 402. In step 404, the target internet server 60 determines whether a Cookie is included in the connection request signal “R_C”. If no Cookie is found in the step 404, the target internet server 60 checks the validity of the temporary ID and password “P” by comparing the temporary ID and password “P” with those received from the connection authentification server 50 in step 414. If the temporary ID and password “P” is determined to be valid in the step 414, the target internet server 60 adds a Set-Cookie field in the header of the HTTP response, the connection permission signal “C_P”, allowing the connection of the local computer 30 (steps 416 and 418). Thus, a Cookie available by the the web browser is stored in the hard disk of the local computer 30. And then, the current session is terminated. If, however, the temporary ID and password “P” is found to be invalid in the step 414, the target internet server 60 transmits the connection refusal signal “D_C” to the local computer 30 in step 420 and terminates the connection procedure.

If a Cookie is found in the step 404, the target internet server 60 checks whether the received Cookie exists in the Cookie list maintained in its database (step 406). Hereinbelow, it is assumed that the received Cookie is “someone abcdefghijkimnopqrstuvwxyz0123456798”. If it is determined that the received Cookie does not exist in the Cookie list in the step 406, the procedure proceeds to the step 420 so that the connection refusal signal “D_C” is transmitted to the local computer 30 and the connection procedure is terminated. On the other hand, if the received Cookie exists in the Cookie list in the step 406, the procedure proceeds to the step 408.

In step 408, it is determined whether the effective time period for the Cookie has expired. Such a determination may take the temporary ID and password “P” into account. For example, let's assume that the Cookie list in the target internet server 60 includes data “abcdefghijklmnopqrstuvwxyz0123456798 192.68.0.2 23/14117104/2000 23/15117104/2000”. Here, “23/14/17/04/2000” denotes the authentification time (mm/hh/dd/mm/yy) of the temporary ID and password “P”, and “23/15/17/04/2000” denotes the expiring time of the temporary ID and password “P”. If the target internet server 60 receives the connection request signal “R_C” with the Cookie “someone=abcdefghijklmnopqrstuvwxyz0123456798” from a local computer 30 having an IP address “192.68.0.2” at “42/14/17/04/2000”, the connection authentification server 50 determines the Cookie to be valid because the current time is between the authentification time and the expiring time of the temporary ID and password “P” and the Cookie value for the “someone” is correct. If it is determined that the effective time period for the Cookie has not expired yet in step 408, the procedure proceeds to step 410. On the other hand, if the effective time period for the Cookie has expired in step 408 the target internet server 60 transmits the connection refusal signal “D_C” to the local computer 30 and terminates the connection procedure (step 422).

In step 410, the target internet server 60 checks whether the local computer identifier “N” is the same as the IP address of the local computer “192.68.0.2” in the Cookie list. If the identifier “N” is different from the IP address of the local computer, the target internet server 60 transmits the connection refusal signal “D_C” to the local computer 30 (step 422), transmits the connection refusal signal “D_C” to the local computer 30 (step 420), and terminates the connection procedure. If the local computer identifier “N” is the same as the IP address of the local computer in the Cookie list, the target internet server 60 transmits the connection admission signal “C_P” to the local computer 30 (step 412).

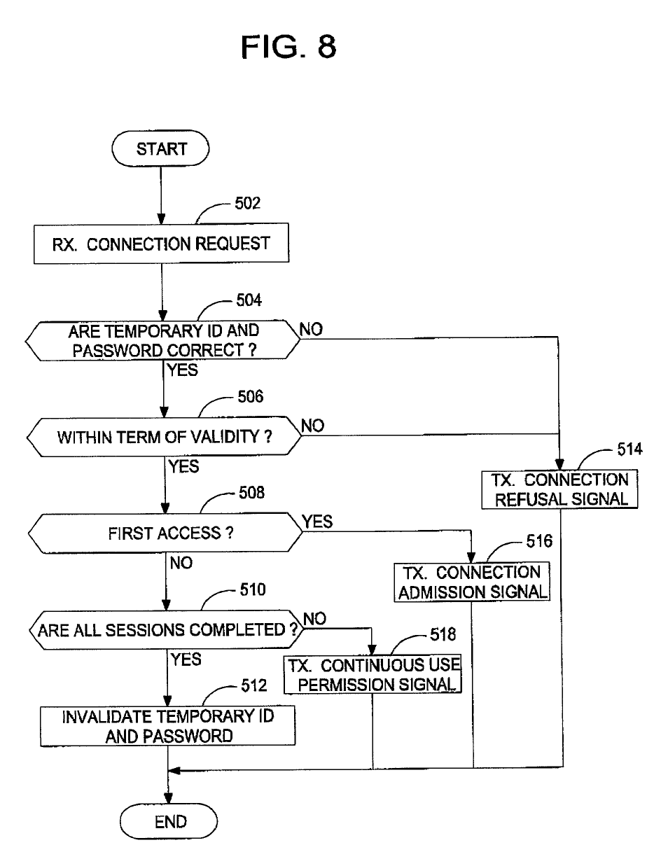

FIGS. 8 illustrates the connection procedure in the target Internet server 60 in the case that the local computer requests services according to a protocol other than the HTTP. In the Internet services using a protocol such as FTP, a session is continued for a certain time is once the local computer 30 is connected to the server. Also, the session is completed when the internet client is terminated. Thus, it is preferable to invalidate the temporary ID and password “P” when the session is completed, i.e., when the connection to the local computer 30 is terminated.

In step 502, the target internet server 60 receives the connection request signal “R_C” from the local computer 30. In step 504, the target internet server 60 determines whether the temporary ID and password “P” from the local computer 30 is identical with those stored in the server 60. If the temporary ID and password “P” from the local computer 30 is different from those stored in the server 60 in the step 504, the target internet server 60 transmits the connection refusal signal “D_C” to the local computer 30 in step 514 and terminates the connection procedure. If the temporary ID and password “P” from the local computer 30 is the same as those stored in the server 60 in the step 504, the target internet server 60 determines whether the effective time limit for the temporary ID and password “P” is not expired in step 506.

If the temporary ID and password “P” is found to be invalid in the step 506, the target internet server 60 transmits the connection refusal signal “D_C” to the local computer 30 in the step 514 and terminates the connection procedure. If the temporary ID and password “P” is determined to be valid in the step 506, the process proceeds to step 508.

In the step 508, the target internet server 60 checks whether the local computer 30 has made a connection before using the temporary ID and password “P”. The target internet server 60 can check the reuse of the temporary ID and password “P” since the server 60 stores the temporary ID and password “P” whenever a connection is established. If it is determined that the temporary ID and password “P” was not used before, the target internet server 60 transmits the connection permission signal “C_P” to the local computer 30 (step 516). If, however, it is determined that the temporary ID and password “P” was found to have been used before, the process proceeds to step 510.

In the step 510, the target internet server 60 checks whether all sessions initiated previously are completed or not. If it is determined that there exists any session initiated previously but not completed yet, the target internet server 60 invalidates the temporary ID and password “P” in step 512 Here, the completion of a session means that the local computer 30 terminated the use of services provided by the target internet server 60. Thus, when all sessions are terminated, it is preferable to refuse any access trial using the temporary ID and password “P” already having been used.

If it is determined, in the step 510, that all the sessions initiated previously are completed but not completed yet, the target internet server 60 transmits a continuous use permission signal “C_U” allowing multiple session accesses to the local computer 30. The allowance of multiple session accesses means that the target internet server 60 allows the user of the local computer 30 to receive a plurality of services simultaneously from the server 60 using a single local computer. Here, it should be noted that the plurality of services preferably are requested and received by a single user. In the case that the target internet server 60 allows multiple session accesses, the server 60 may compulsorily terminate all the pending sessions or inhibit setting of further session when the effective time limit of the temporary ID and password “P” expires.

Having described and illustrated the principles of the invention in preferred embodiments and alternatives thereof, it should be understood that the foregoing description is illustrative and not restrictive and the invention can be modified in arrangement and detail without departing from such principles. We claim all modifications and variation coming within the spirit and scope of the following claims.

What is claimed is:

1. A method for supporting an establishment of a communication channel between a client computer capable of accessing an information storage medium which stores predetermined information contents and a connection information including medium identification data and a first remote server providing services related to the information contents through a open communication network, wherein said method comprises the steps of:
(a) providing a second remote server comprising means for storing medium identification reference data required to be identical with the medium identification data;
(b) receiving a connection authentification request message including the medium identification data from the client computer through the open communication network; and
(c) when the medium identification data is same as the medium identification reference data, generating an access code and transmitting an encrypted access code to the client computer, so that the client computer tries to establish a connection to the first remote server using the access code and receive the services.

2. The method as claimed in claim 1, wherein said step (c) comprises the steps of:
(c1) generating the access code;
(c2) encrypting the access code; and
(c3) transmitting an encrypted access code to the client computer through the open communication network.

3. The method as claimed in claim 2, further comprising the step of:
(d) transmitting an authentification notifying message including the access code to the first remote server, so that the first remote server provides the services to the client computer after verifying validity of the access code when the client computer requests a connection.

4. The method as claimed in claim 3, wherein, in said step (b), the connection authentification request message further includes an address of the client computer on the open communication network,
wherein, in said step (d), the authentification notifying message further includes the address of the client computer,
wherein the first remote server verifies validity of the access code as well as the validity of the address of the client computer when the client computer requests the connection.

5. The method as claimed in claim 3, wherein the authentification notifying message further includes time data for setting an expiration period of the access code, so that the first remote server invalidates the access code when the client computer does not request the connection within the expiration period.

6. The method as claimed in claim 2, wherein at least a portion of the connection authentification request message is encrypted according to a predetermined encryption algorithm,
wherein said step (b) comprises a step of: decrypting the encrypted portion of the connection authentification request message.

7. The method as claimed in claim 6, wherein, in said step (b), the connection authentification request message further includes an address of the client computer on the open communication network,
wherein, in said step (d), the authentification notifying message further includes the address of the client computer,
wherein the first remote server verifies validity of the access code as well as the address of the client computer when the client computer requests the connection.

8. The method as claimed in claim 1, wherein both the first and the second remote servers are implemented in a same physical server and assigned with the same network address with each other.

9. The method as claimed in claim 8, wherein the access code includes a Cookie value transmitted from the second remote server to the client computer through a Cookie-setting field to be stored in the client computer.

10. A computer readable medium storing a program for setting up a communication channel between a client computer and a first remote server through an open communication network in a condition that the client computer can access an information storage medium storing predetermined information contents and a connection information including medium identification data and address data of a second remote server, said program carries out the functions of:
(a) making a connection authentification request message generated based on the connection information to be transmitted to the second remote server through the open communication network;
(b) receiving and decoding a connection authentification message provided by the second remote server in response to the connection authentification request message to recover an access code assigned by the second remote server; and
(c) providing the access code to a predetermined client program operating in the client computer so that the client program tries to establish a connection to the first remote server using the access code and receive services related to the information contents from the first remote server.

11. The computer readable medium as claimed in claim 10, wherein the computer readable medium is the same as the information storage medium, and thus the information contents, the connection information, and the program are stored in a single medium.

12. The computer readable medium as claimed in claim 10, wherein said function (a) comprises the functions of;
(a1) reading out the medium identification data and the address data of the second remote server from the information storage medium; and
(a2) providing the client program with the medium identification data and the address data of the second remote server, so that the client program generates the connection authentification request message using the medium identification data and transmits the connection authentification request message to the second remote server.

13. The computer readable medium as claimed in claim 12, wherein said function (a2) comprises the functions of:
(a2a) encrypting the medium identification data; and
(a2b) providing the client program with an encrypted medium identification data and the address data of the second remote server.

14. The computer readable medium as claimed in claim 10, wherein said function (a) comprises the functions of:
(a1) reading out the medium identification data and the address data of the second remote server from the information storage medium; and
(a2) generating the connection authentification request message using the medium identification data; and
(a3) making the connection authentification request message to be transmitted to the second remote server.

15. The computer readable medium as claimed in claim 14, wherein said function (a2) comprises the function of: encrypting at least a portion, including the medium identification data, of the connection authentification request message.

16. The computer readable medium as claimed in claim 14, wherein said function (a3) comprises the function of: transferring the connection authentification request message to the client program, so that the client program transmits the connection authentification request message to the second remote server.

17. The computer readable medium as claimed in claim 14, wherein said function (a3) comprises the function of: directly transmitting, without an intervention of the client program, the connection authentification request message to the second remote server.

18. The computer readable medium as claimed in claim 10 wherein, in said function (a), the connection authentification request message further includes an address of the client computer on the open communication network.
